(19) United States
(12) Patent Application Publication
(10) Pub. No.: US 2019/0004956 A1
(43) Pub. Date: Jan. 3, 2019

(54) COMPUTER SYSTEM AND CACHE MANAGEMENT METHOD FOR COMPUTER SYSTEM

(71) Applicant: HITACHI, LTD., Tokyo (JP)

(72) Inventors: Tadashi TAKEUCHI, Tokyo (JP); Sachie TAJIMA, Tokyo (JP)

(73) Assignee: HITACHI, LTD., Tokyo (JP)

(21) Appl. No.: 15/534,157

(22) PCT Filed: Feb. 23, 2015
(86) PCT No.: PCT/JP2015/054949

§ 371 Date: Jun. 8, 2017

(51) Int. Cl. G06F 12/0864; G06F 3/06

(52) U.S. Cl. CPC G06F 12/0864; G06F 3/0608; G06F 2212/1044; G06F 3/0656; G06F 3/0673; G06F 3/0641

(57) ABSTRACT

A cache state management mechanism manages the cache state of each of a first virtual computer and a second virtual computer, and if the cache state management mechanism detects a cache state transition, then a virtualization mechanism performs deduplication processing if duplicated regions are found. If the second virtual computer accesses a cache that was associated with a released memory region, causing predetermined exception handling to occur, then the virtualization mechanism associates a prescribed memory region with the cache for which the predetermined exception handling has occurred, converts data stored in the cache that is used by the first virtual computer and that is associated with the duplicated memory region corresponding to released memory region, so that the converted data matches the cache configuration of the second virtual computer, instead of the cache configuration of the first virtual computer, and copies the converted data to the predetermined memory region.

### TECHNICAL FIELD

The present invention relates to a computer system and a cache management method for a computer system.

### BACKGROUND ART

Performing deduplication of a cache memory in an environment where a plurality of virtual machines are present is known (PTL 1). Techniques for performing deduplication of a memory area in an environment having a virtual machine are also known (PTL 2 and PTL 3).

### CITATION LIST

### Patent Literature

### [PTL 1]

### US Patent Application Publication No. 2013/0198459 (Specification)

### [PTL 2]

### US Patent Application Publication No. 2013/0346975 (Specification)

### [PTL 3]

### US Patent Application Publication No. 2010/0023941 (Specification)

### SUMMARY OF INVENTION

### Technical Problem

Storing same data in duplicate uses a memory area in a wasteful manner and causes a decline in use efficiency of the memory area. However, deduplication processing which involves detecting data stored in duplicate in a plurality of memory areas and eliminating any of the duplicate data imposes a heavy load on a CPU (Central Processing Unit). Therefore, performing the deduplication processing may possibly affect performance of other processes.

The present invention has been made in consideration of the problem described above and an object thereof is to provide a computer system and a cache management method of a computer system configured to enable deduplication processing to be efficiently performed while suppressing processing load.

### Solution to Problem

In order to solve the problem described above, a computer system according to the present invention is provided with: a physical resource including a memory; a virtualization mechanism configured to provide a first virtual computer and a second virtual computer by allocating the physical resource and to manage a cache configuration of the first virtual computer and a cache configuration of the second virtual computer in association with each other; and a cache state management mechanism configured to manage a cache state of each of the virtual computers, wherein the cache state management mechanism manages respective cache states of the first virtual computer and the second virtual computer; upon detection of a transition of the cache state by the cache state management mechanism, when there is a duplicated area which stores same data in a memory area associated with a cache of the first virtual computer and a memory area associated with a cache of the second virtual computer, the virtualization mechanism executes deduplication processing which releases the memory area of the second virtual computer corresponding to the duplicated area by releasing an association between the memory area and the cache of the second virtual computer; and when prescribed exception handling occurs due to the second virtual computer accessing the cache previously associated with a released memory area, the virtualization mechanism associates a prescribed memory area with the cache in which the prescribed exception handling has occurred, converts data stored in the cache of the first virtual computer corresponding to the duplicated area from the cache configuration of the first virtual computer to the cache configuration of the second virtual computer, and copy the converted data to the prescribed memory area.

The virtualization mechanism can also be configured to perform management so that usage of the prescribed memory area equals or falls below a prescribed amount.

The virtualization mechanism can also be configured to migrate to a state where the deduplication processing is not executed when a frequency of occurrences of the prescribed exception handling exceeds a prescribed reference value.

The virtualization mechanism can also be configured to migrate to a state where the deduplication processing is executable when the frequency of occurrences of the prescribed exception handling equals or falls below the prescribed reference value.

### Advantageous Effects of Invention

According to the present invention, since deduplication processing is executed in a case where a duplicated area is present when a transition of a cache state occurs, the deduplication processing can be executed in an efficient manner. In addition, according to the present invention, when data from which duplication is eliminated by the deduplication processing is accessed, the data is converted from a cache configuration of a first virtual computer to a cache configuration of a second virtual computer and copied to a prescribed memory area. Therefore, even when the cache configuration of the first virtual computer and the cache configuration of the second virtual computer differ from each other, deduplication processing can be executed in an efficient manner.

### BRIEF DESCRIPTION OF DRAWINGS

FIG. 1 is a diagram illustrating a configuration of a software module of a computer system.

FIG. 2 is a diagram illustrating a configuration of a hardware module of a computer system.

FIG. 3 is a diagram illustrating a data structure of a cache area of a first guest OS and a data structure of a cache area of a second guest OS.

FIG. 4 is a diagram illustrating a data structure of cache format information.

FIG. 5 is a diagram illustrating a data structure of a page exception occurrence counter.

FIG. 6 is a diagram illustrating a data structure of a memory allocation table.

FIG. 7 is a diagram illustrating a data structure of a host physical page queue.

FIG. 8 is a diagram illustrating a data structure of a copied page queue.

FIG. 9 is a diagram illustrating a state transition of a cache entry managed by a first guest OS and a state transition of a cache entry managed by a second guest OS.

FIG. 10 is a diagram illustrating a data structure of an address conversion table.

FIG. 11 is a flow chart showing an operation flow of a cache management mechanism of a second guest OS.

FIG. 12 is a flow chart showing an operation flow of a cache management mechanism of a first guest OS.

FIG. 13 is a flow chart showing an operation flow of a cache state management mechanism.

FIG. 14 is a flow chart showing an operation flow in a case where a memory allocation management mechanism receives a page absenting request.

FIG. 15 is a flow chart showing an operation flow in a case where a memory allocation management mechanism receives a page allocation request.

FIG. 16 is a flow chart showing an operation flow of a cache copy mechanism.

FIG. 17 is a diagram illustrating a method of determining a copy source address and a copy destination address.

FIG. 18 is a flow chart showing a cache data copy process.

### DESCRIPTION OF EMBODIMENTS

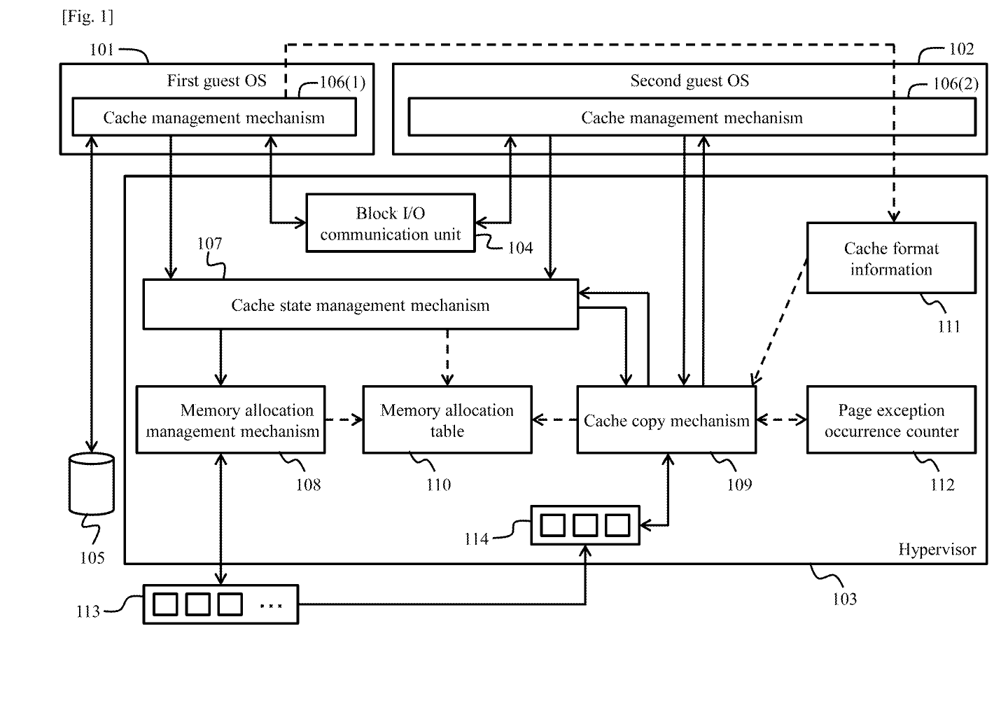

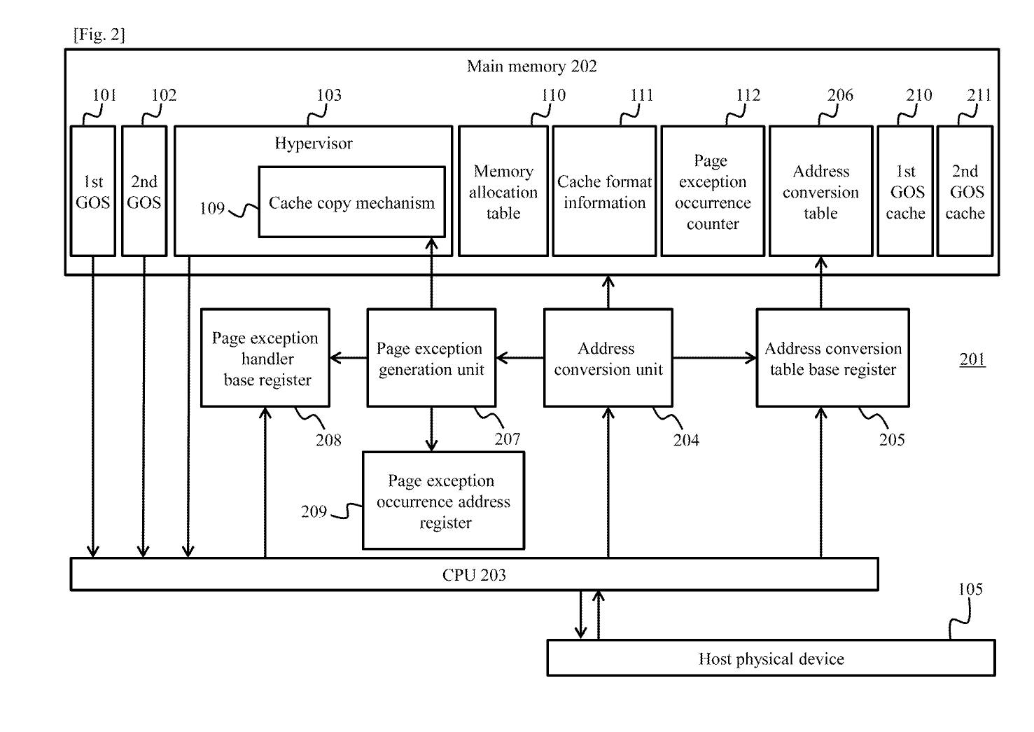

Hereinafter, an embodiment of the present invention will be described with reference to the drawings. As shown in FIG. 1 and FIG. 2, a first guest OS (operating system) 101 and a second guest OS 102 run in parallel on a computer 201 (refer to FIG. 2) according to the present embodiment. The guest OSs 101 and 102 are provided by a hypervisor 103 as a virtualization mechanism. The first guest OS 101 is an example of a “first virtualized computer” and controls a physical block device 105. The second guest OS 102 is an example of a “second virtual computer” and operates a file system used by an application.

The second guest OS 102 issues a block I/O request to a virtual block device (not shown) provided by the first guest OS 101. Upon receiving the block I/O request from the second guest OS 102, the first guest OS 101 issues a block I/O request to a host physical device 105 that is a physical block device.

In accordance with the issuance of the I/O requests, the OSs 101 and 102 notify the hypervisor 103 of a guest OS address of a cache area for each virtual block size respectively managed by the OSs 101 and 102, a block number of a corresponding virtual block device, and a cache state.

In this case, the cache state is any one of a “clean state”, a “dirty state”, and a “non-existent state”. The “clean state” refers to a state where contents written to a block device to be an issuance source of a block I/O request of the block device's own OS and contents of a cache are consistent with each other. In other words, the clean state is a state where same target data is respectively stored in the cache and the physical block device and no problems may occur even when the target data on the cache is lost. This is because the target data can be read from the physical block device and stored in a cache memory.

The “dirty state” refers to a state where contents written to a block device to be an issuance source of a block I/O request of the block device's own OS and contents of a cache are inconsistent. In other words, the dirty state is a state where target data only exists on the cache and is not stored in the physical block device. The “non-existent state” refers to a state where target data does not exist on the cache.

The hypervisor 103 manages cache states of the first guest OS 101 and the second guest OS 102 for each block number of a virtual block device provided by the first guest OS 101. When the cache state of the second guest OS 102 is the “clean state” and the cache state of the first guest OS 101 is either the “clean state” or the “dirty state”, the hypervisor 103 determines that contents of cache areas managed by both OSs 101 and 102 are the same. In other words, when these cache states exist, the hypervisor 103 determines that data is stored in duplicate.

In this case, as one method, the hypervisor 103 can update memory map information of each of the guest OSs 101 and 102 so that both cache areas share a same host physical memory. As a result, an amount of the host physical memory consumed by both OSs 101 and 102 can be reduced and cases where the same data is stored in duplicate can be eliminated.

When the first guest OS 101 and the second guest OS 102 respectively store cache areas having the same contents, by having both OSs share a host physical memory, usage of the host physical memory can be reduced.

While a case where a storage format of data to a cache entry managed by the first guest OS 101 is consistent with a storage format of data to a cache entry managed by the second guest OS 102 poses no problem, there are also cases where the data storage formats are not consistent with each other.

Examples in which a storage format of cache data managed by the first guest OS 101 differs from a storage format of cache data managed by the second guest OS 102 include cases where cache entry sizes and data arrangement formats inside cache entries differ from each other. In such cases, although contents of data respectively cached by the guest OSs 101 and 102 are consistent, data arrays on a host physical memory differ from each other. Therefore, with the deduplication system described above, both guest OSs 101 and 102 are unable to share a physical memory and, consequently, usage of a host physical memory cannot be reduced. This is because a difference in arrays at storage destinations even though contents are the same prevents data from being accurately read, used, and updated.

The present embodiment improves the deduplication system described above so that, even when a cache storage format of the first guest OS 101 differs from a cache storage format of the second guest OS 102, deduplication of both caches are realized and an amount of consumed host physical memory is reduced.

In the present embodiment, the hypervisor 103 runs on the computer 201 mounted with a CPU 203, a main memory 202, and an I/O device 105. The hypervisor 103 provides the first guest OS 101 and the second guest OS 102. The first guest OS 101 and the second guest OS 102 which run on the hypervisor 103 operate while accessing the main memory 202 and the I/O device 105 on the CPU 203.

The hypervisor 103 maps a page of the main memory 202 on the computer 201 to a guest OS physical address space of the first guest OS 101 and a guest OS physical address space of the second guest OS 102.

The first guest OS 101 provides the second guest OS 102 with a virtual block device. The second guest OS 102 transmits a block I/O request to the virtual block device. In addition, upon receiving the block I/O request from the second guest OS 102, the first guest OS 101 issues a device I/O request to the I/O device 105.

The first guest OS 101 caches a part of the data stored in the I/O device 105 in a cache entry of a cache area managed by the OS 101 itself. The second guest OS 102 caches a part of the data stored in the virtual block device in a cache entry of a cache area managed by the OS 102 itself. Although the second guest OS 102 recognizes that the data is stored in the virtual block device, in reality, the data is stored in the I/O device 105.

The hypervisor 103 stores format information of a cache entry managed by the first guest OS 101 and format information of a cache entry managed by the second guest OS 102. The hypervisor 103 stores memory allocation tables 110 (1) and 110 (2) which manage associations between the respective cache entries managed by the first guest OS 101, respective cache entries managed by the second guest OS 102, and a block number of the virtual block device. A memory allocation management table can be prepared for each of the guest OSs 101 and 102.

The first guest OS 101 and the second guest OS 102 notify the hypervisor 103 of a state change to a cache entry in respectively managed cache areas. Based on the cache state of the first guest OS 101 and the cache state of the second guest OS 102, the hypervisor 103 determines whether or not deduplication of a cache entry of the second guest OS 102 is feasible.

When the hypervisor 103 determines that the deduplication of a cache entry of the second guest OS 102 is feasible, the hypervisor 103 releases mapping of a host physical page used by the cache entry of the second guest OS 102 to the guest OS physical address space of the second guest OS 102. In other words, with respect to a cache entry of the second guest OS 102 storing the same data as data stored in a cache entry of the first guest OS 101, the hypervisor 103 releases association of a host physical page associated with the cache entry.

After duplicate storage of data is released, the second guest OS 102 may access a cache entry of which association with a host physical page has been released. An access by the second guest OS 102 to a cache entry not associated with a host physical page causes a page exception as “prescribed exception handling”.

The occurrence of a page exception triggers activation of the hypervisor 103. The hypervisor 103 determines a block number of a virtual block device corresponding to the cache entry in which the page exception has occurred and a cache entry of the first guest OS 101 corresponding to the block number by searching in the memory allocation table 110.

The hypervisor 103 maps a host physical page to a cache entry area in the guest OS physical address space of the second guest OS 102. In other words, the hypervisor 103 associates a host physical page with the cache entry in which the page exception has occurred.

In addition, in accordance with cache format information 111, the hypervisor 103 copies contents of the cache entry of the first guest OS 101 to a host physical page associated with the cache entry in which the page exception has occurred.

According to the present embodiment, since a storage area can be shared even when the cache format of the first guest OS 101 differs from the cache format of the second guest OS 102, an amount of physical memory mapped to a cache area in the guest OS physical address space of the second guest OS 102 can be reduced. In other words, even when a storage format of a cache entry in the first guest OS 101 differs from a storage format of a cache entry in the second guest OS 102, a difference between the storage formats can be absorbed and duplicated data can be eliminated. Furthermore, when necessary, data managed by the first guest OS 101 can be copied to and restored in a host physical page associated with a cache entry of the second guest OS 102.

### Embodiment 1

FIG. 1 shows a configuration example of a software module of the computer 201. FIG. 2 shows a configuration example of a hardware module of the computer 201. First, the configuration example of a software module will be described.

The first guest OS 101 and the second guest OS 102 run in parallel on the hypervisor 103. The first guest OS 101 provides the second guest OS 102 with a virtual block device. The second guest OS 102 transmits a block I/O request targeting the virtual block device to the first guest OS 101. The block I/O request issued by the second guest OS 102 is transferred to the first guest OS 101 via a block I/O communication unit 104. Upon receiving the block I/O request from the second guest OS 102, the first guest OS 101 issues a device I/O request to the host physical device 105.

The first guest OS 101 and the second guest OS 102 both cache data stored by a lower-level block device (a virtual block device or a host physical device) in a cache area managed by the OS itself. In other words, the first guest OS 101 reads desired data in a group of data stored by the host physical device 105 and copies the read data in a cache area managed by the first guest OS 101. The second guest OS 102 reads desired data in a group of data stored by the virtual block device and copies the read data in a cache area managed by the second guest OS 102. However, as described earlier, the virtual block device is a block device provided by the first guest OS 101 to the second guest OS 102 and actual data is stored in the host physical device 105.

The first guest OS 101 and the second guest OS 102 have cache management mechanisms 106 (1) and 106 (2) which manage respective cache states thereof. The respective cache management mechanisms 106 (1) and 106 (2) notify a cache state management mechanism 107 of the hypervisor 103 of a change to a cache state.

In other words, when a cache state of a cache area managed by the first guest OS 101 is changed, the cache management mechanism 106 (1) of the first guest OS 101 notifies the cache state management mechanism 107 in the hypervisor 103 of the cache state change. In a similar manner, when a cache state of a cache area managed by the second guest OS 102 is changed, the cache management mechanism 106 (2) of the second guest OS 102 notifies the cache state management mechanism 107 in the hypervisor 103 of the cache state change. Hereinafter, the cache management mechanism 106 (1) and the cache management mechanism 106 (2) will be referred to as the cache management mechanism 106 when the cache management mechanism 106 (1) and the cache management mechanism 106 (2) need not be particularly distinguished from each other.

The cache state management mechanism 107 determines feasibility of deduplication based on a cache state notified from each cache management mechanism 106. When the cache state management mechanism 107 determines that deduplication is feasible, the cache state management mechanism 107 issues an absenting request of the host physical page having been used as a cache area of the second guest OS 102 to a memory allocation management mechanism 108.

Upon receiving the absenting request, the memory allocation management mechanism 108 returns the host physical page having been used as the cache area of the second guest OS 102 to a host physical page queue 113.

Conversely, when deduplication having been performed subsequently becomes infeasible, the cache state management mechanism 107 issues a page allocation request to the memory allocation management mechanism 108. Upon receiving the page allocation request, the memory allocation management mechanism 108 reserves a host physical page from the host physical page queue 113 and allocates the host physical page to the cache area of the second guest OS 102.

In addition, the cache state management mechanism 107 issues a pseudo page exception notification to a cache copy mechanism 109. A pseudo page exception notification refers to artificially generating a notification to be transmitted upon an occurrence of a page exception and transmitting the notification. Upon receiving the pseudo page exception notification, the cache copy mechanism 109 copies data from the duplicated cache area of the first guest OS 101 to the newly reserved host physical page. In other words, data prior to deduplication is read from a cache area (the cache area of the first guest OS 101) storing the data and copied to the host physical page newly allocated to the cache area of the second guest OS 102. Accordingly, a deduplication state is released and the same data is stored in both the cache area of the first guest OS 101 and the cache area of the second guest OS 102.

As a result of an absenting process, the host physical page having been allocated to the cache area of the second guest OS 102 is returned to the host physical page queue 113. When the second guest OS 102 accesses the cache area subjected to the absenting process, a page exception occurs. This is because the host physical page to be accessed no longer exists. When the page exception occurs, the cache copy mechanism 109 is activated.

Based on the cache format information 111 registered in advance, the cache copy mechanism 109 attempts to restore contents of the host physical page allocated to the cache area subjected to the absenting process. The cache format information 111 stores a correspondence between a cache configuration managed by the first guest OS 101 and a cache configuration of the second guest OS 102.

The cache copy mechanism 109 performs control so that the number of host physical pages enqueued in a copy page queue 114 becomes constant. The cache copy mechanism 109 issues a page absenting request of a host physical page enqueued to a head of the copy page queue 114 to the memory allocation management mechanism 108. At the same time, the cache copy mechanism 109 issues an allocation request of a new host physical page to the memory allocation management mechanism 108.

Based on cache format information, the cache copy mechanism 109 copies contents of a corresponding cache area of the first guest OS 101 onto the host physical page newly enqueued to the copy page queue 114.

The number of times page exception handling is executed by the cache copy mechanism 109 is counted by a page exception occurrence counter 112. When page exceptions occur in excess of a prescribed reference value or, in other words, when page exceptions occur at a frequency equal to or higher than a prescribed value, cache copy processes are being frequently performed. Performing a cache copy process causes performance of the computer 201 to decline. In consideration thereof, in order to suppress a decline in performance due to performing a cache copy process, the cache copy mechanism 109 issues a stop request of a page absenting process to the cache state management mechanism 107. Conversely, when a frequency at which page exception handling is executed falls to or below the prescribed reference value, the cache copy mechanism 109 issues a start request of a page absenting process to the cache state management mechanism 107.

Let us now refer to the configuration example of a hardware module shown in FIG. 2. A cache deduplication method according to the present embodiment is realized as a program which runs on the computer 201.

The computer 201 is an example of a “computer system”. The computer 201 includes, for example, the main memory 202, the CPU 203, and the host physical device 105. In addition to computer programs (not shown) for realizing cache deduplication, data structures or cache areas referenced by the computer programs and a table for controlling an address conversion unit 204 provided by the computer 201 are arranged on the main memory 202.

As computer programs, the hypervisor 103 including the first guest OS 101, the second guest OS 102, and the cache copy mechanism 109 is arranged in the main memory 202. These programs 101, 102, and 103 are loaded to and executed by the CPU 203.

As data structures, the memory allocation table 110, the cache format information 111, the page exception occurrence counter 112, the host physical page queue 113, and the copy page queue 114 are arranged in the main memory 202. As cache areas, a first guest OS cache area 210 and a second guest OS cache area 211 are arranged in the main memory 202.

A program loaded to the CPU 203 accesses data structures 110 to 114 and cache areas 210 and 211 via the address conversion unit 204. The address conversion unit 204 enables each program to access the main memory 202 in a different address space in accordance with contents of an address conversion table 206 specified by an address conversion base register 205. In other words, the first guest OS 101 can access the main memory 202 in a first guest OS address space. The second guest OS 102 can access the main memory 202 in a second guest OS address space.

When a program attempts to access an absent page using the address conversion table 206, the address conversion unit 204 activates a page exception generation unit 207. The page exception generation unit 207 writes an address to which an access has been attempted into a page exception occurrence address register 209 and, at the same time, starts a program beginning at an address set in a page exception handler base register 208. A start address of a program for realizing the cache copy mechanism 109 is registered in the page exception handler base register 208. Therefore, the page exception generation unit 207 activates the cache copy mechanism 109.

The programs 101, 102, and 103 loaded onto the CPU 203 are capable of issuing an I/O request to the host physical device 105. As a result, data is transferred between the first guest OS cache area 210 or the second guest OS cache area 211 and the host physical device 105. Once data transfer is completed, the host physical device 105 transmits an I/O completion notification to the CPU 203.

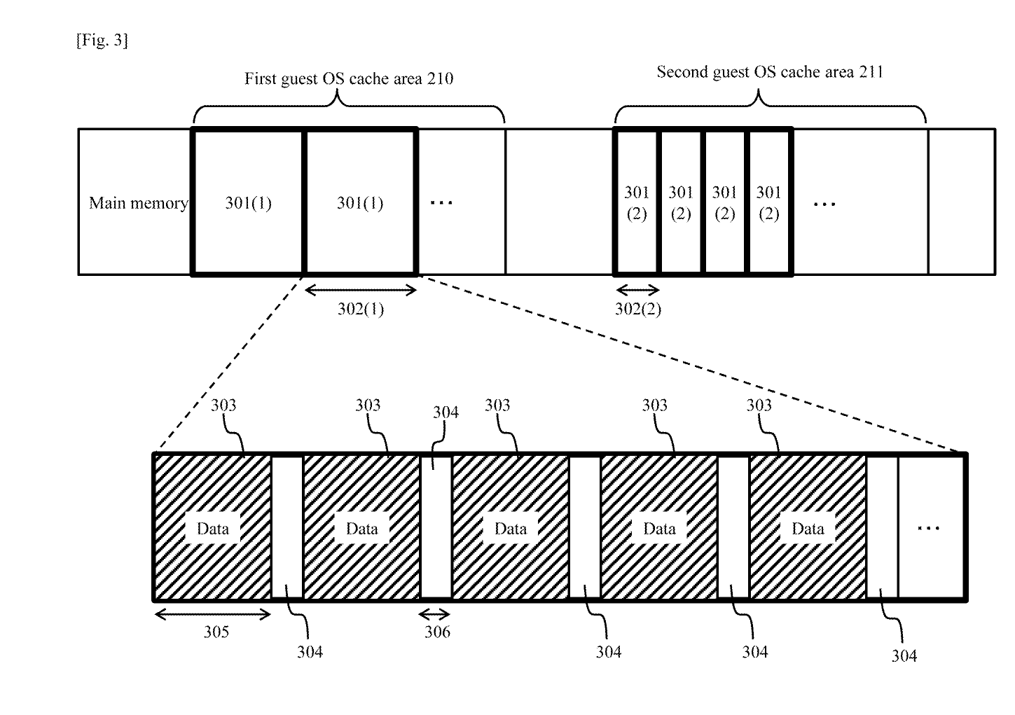

FIG. 3 shows respective data structures of the first guest OS cache area 210 and the second guest OS cache area 211 which exist on the main memory 202.

The first guest OS cache area 210 and the second guest OS cache area 211 are respectively divided into fixed-length cache entries 301. The first guest OS cache area 210 is divided into a plurality of cache entries 301 (1) having a fixed-length entry size 302 (1). In a similar manner, the second guest OS cache area 211 is divided into a plurality of cache entries 301 (2) having a different fixed-length entry size 302 (2).

In the present embodiment, each cache entry 301 (1) managed by the first guest OS 101 is constructed as an aggregate of a data section 303 and a gap section 304. The data section 303 is an area for storing a main body of data and has a fixed-length data size 305. The gap section 304 is an area arranged between data sections 303 and has a fixed-length data size 304. The gap section 304 stores information for inspecting reliability of data stored in the data section 303 such as a CRC (Cyclic Redundancy Code) or a logical address.

Moreover, in the following description, when a cache entry on a side of the first guest OS and a cache entry on a side of the second guest OS are not particularly distinguished from each other, the cache entries will be referred to as a cache entry 301 and an entry size 302.

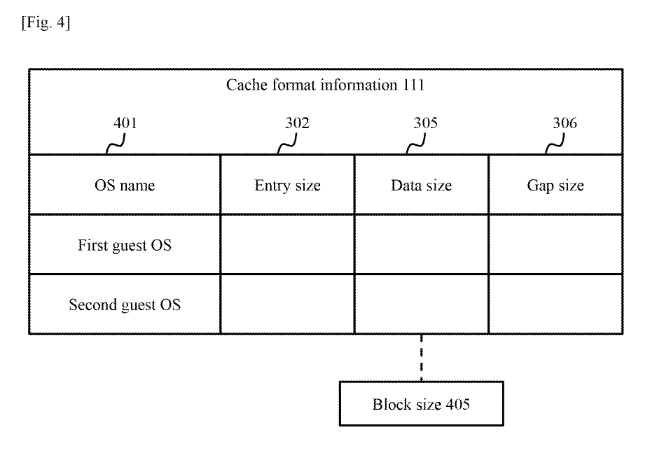

FIG. 4 shows a data structure of the cache format information 111. The cache format information 111 is information which manages a structure of a cache area managed by the first guest OS 101 and a structure of a cache area managed by the second guest OS 102 in association with each other.

For example, the cache format information 111 stores, for each guest OS, an OS name 401, the entry size 302, the data size 305, and a gap size 306. In addition, the cache format information 111 also stores information on a block size 405 of a virtual block device provided by the first guest OS 101.

The data size 305 is a multiple by n (where n is an integer) of the block size 405. The cache entry 301 stores a prescribed number of blocks of a virtual block device, the prescribed number being a product of the number of data sections 303 included in the cache entry 301 and n described above. The first guest OS 101 and the second guest OS 102 manage respective cache states in units of the prescribed number of blocks.

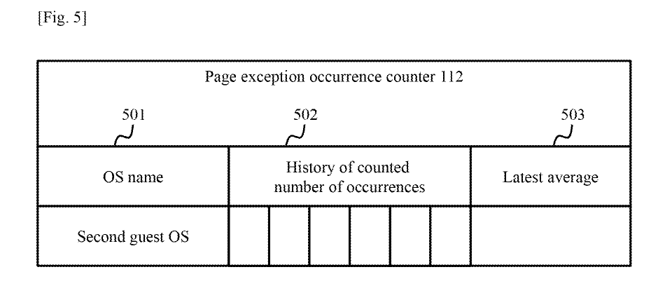

FIG. 5 shows a data structure of the page exception occurrence counter 112. The page exception occurrence counter 112 which counts the number of occurrences of a page exception manages, for example, an OS name 501, a history of counted number of occurrences 502, and a latest average 503.

A counted number of occurrences of a page exception is registered in the history of counted number of occurrences 502 at constant time intervals. An average value of each counted number registered in the history of counted number of occurrences 502 is stored in the latest average 503. By referring to a value of the latest average 503, the cache copy mechanism 109 can promptly acquire a frequency of occurrences of a page exception during a period corresponding to the number of entries in the history of counted number of occurrences 502.

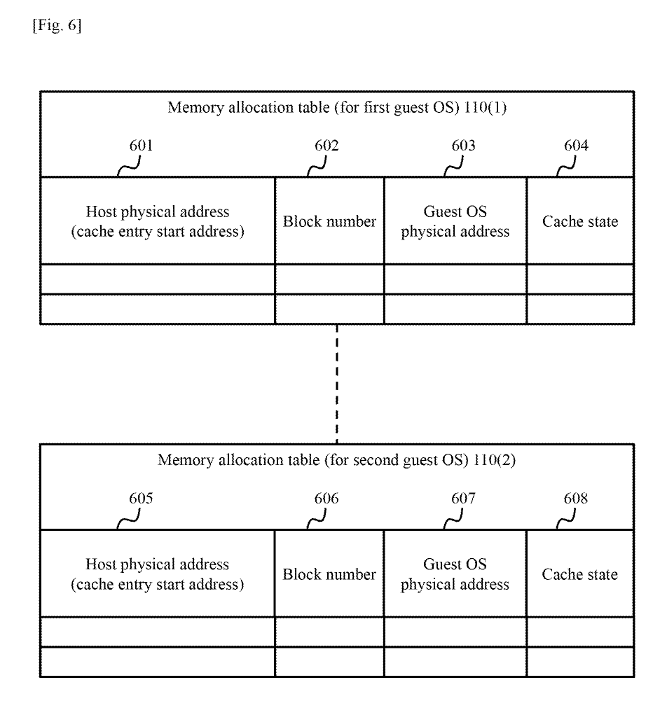

FIG. 6 shows a data structure of the memory allocation table 110. The memory allocation table 110 includes a table 110 (1) for the first guest OS 101 and a table 110 (2) for the second guest OS 102.

The memory allocation table 110 manages memory mapping information of each cache entry 301 (1) in the first guest OS cache area 210, memory mapping information of each cache entry 301 (2) in the second guest OS cache area 211, and respective cache states thereof.

The first guest OS memory allocation table 110 (1) manages a host physical address 601, a block number 602, a first guest OS physical address 603, and a cache state of the cache entry 301 (1) of the first guest OS cache area 210.

In a similar manner, the second guest OS memory allocation table 110 (2) manages a host physical address 605, a block number 606, a second guest OS physical address 607, and a cache state 608 of the cache entry 301 (2) of the second guest OS cache area 211.

The host physical address 601 or 605 and the guest OS physical address 603 or 607 represent mapping information of the cache entry 301. The host physical address 601 or 605 is a start address of the cache entry 301. The block number 602 or 606 represents a block number of a virtual block device stored in a first data section of the cache entry 301. The cache state 604 or 608 represents a state of the cache entry 301.

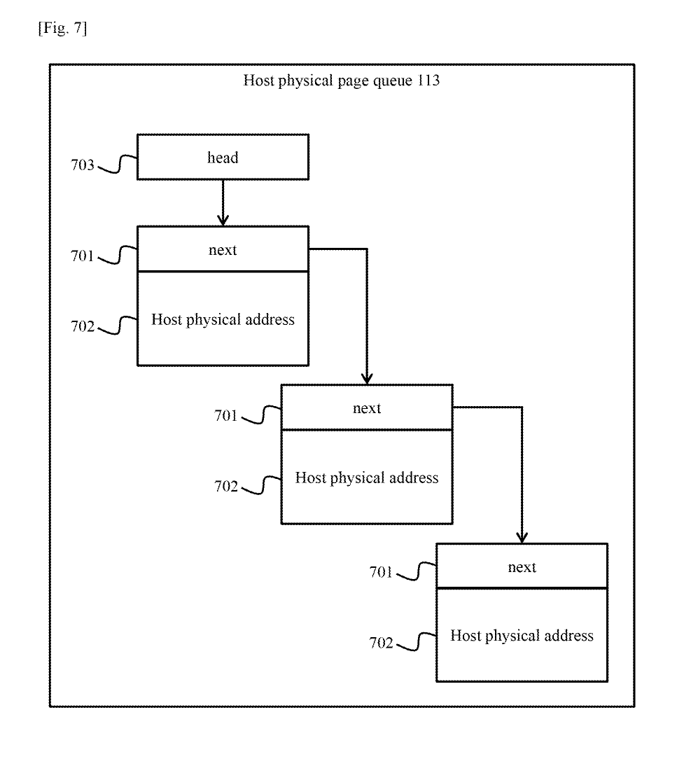

FIG. 7 shows an example of a data structure of the host physical page queue 113. The host physical page queue 113 has a queue structure in which queue elements are connected starting with a queue head 703. Each queue element includes a next field 701 and a host physical address field 702. Each queue element represents a free host physical page.

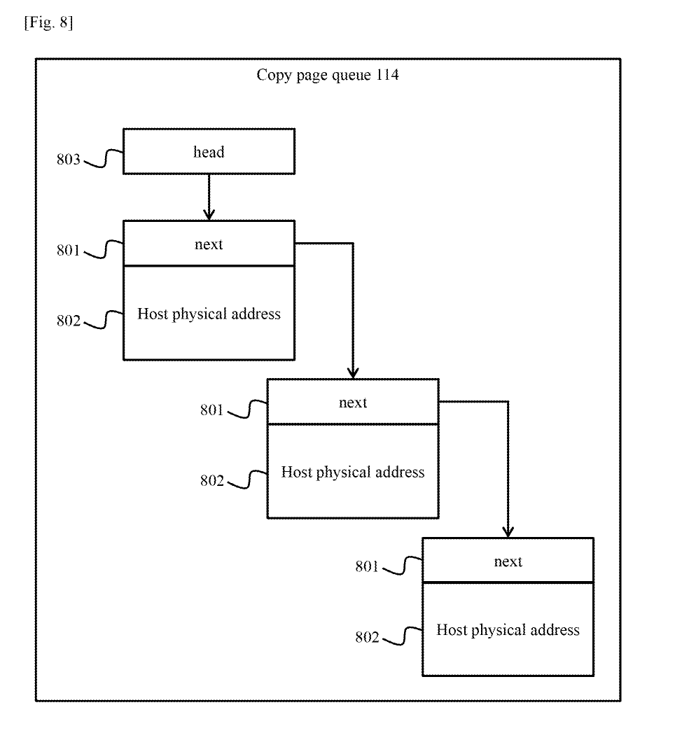

FIG. 8 shows a data structure of the copy page queue 114. The copy page queue 114 has a queue structure similar to the host physical page queue 113 in that queue elements are connected starting with a queue head 803. Each queue element includes a next field 801 and a host physical address field 802. Each queue element represents a host physical page to be used when releasing deduplication.

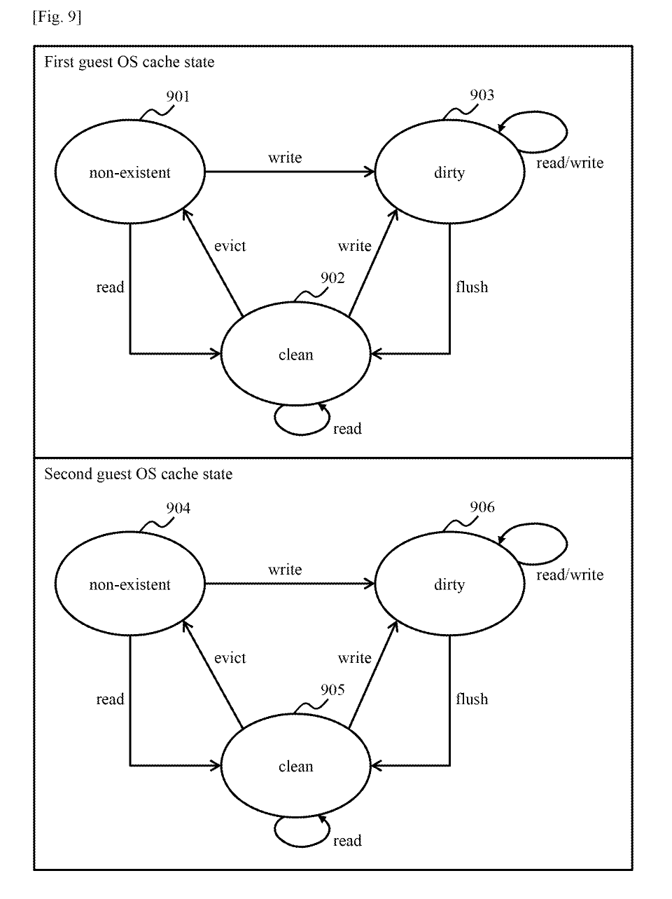

FIG. 9 shows a transition of a cache state. An upper half of FIG. 9 shows a transition of a cache state of the cache entry 301 (1) managed by the first guest OS 101. A lower half of FIG. 9 shows a transition of a cache state of the cache entry 301 (2) managed by the second guest OS 102.

Data of a virtual block device is divided by a total size of data sections 303 managed by the cache entry 301 of each guest OS, whereby the cache state is managed in units of the division.

An initial state is a “non-existent state 901 or 904”. The “non-existent state” indicates that data in division units is not cached in the first guest OS cache area 210 or the second guest OS cache area 211.

When a guest OS receives a read request in the “non-existent state”, the cache entry 301 in division units is reserved. Data of a lower-level block device (the host physical device 105 or a virtual block device) is loaded in the data section 303 of the reserved cache entry 301.

In this case, data stored in the lower-level block device and data stored in the cache entry 301 are consistent with each other. A state where the data stored in the lower-level block device and the data stored in the cache entry 301 are consistent with each other is referred to as a “clean state 902 or 905”.

When a guest OS receives a write request with respect to a division unit in the “non-existent state 901 or 904”, the cache entry 301 for the division unit is reserved. Write data is stored in the data section 303 of the reserved cache entry 301.

In this case, the data stored in the lower-level block device and the data stored in the cache entry 301 are inconsistent. A state where the data stored in the lower-level block device and the data stored in the cache entry 301 are inconsistent is referred to as a “dirty state 903 or 906”.

When desiring to reuse the cache entry 301 in the “dirty state 903 or 906” as an area to cache other data in division units, a process (a flush process) of writing data in the dirty state to a lower-level block device (the host physical device 105 or a virtual block device) is executed. As a result, since the data written to the lower-level block device and the data stored in the cache entry 301 are consistent with each other, the cache state makes a transition from the “dirty state 903 or 906” to the “clean state 902 or 905”.

Furthermore, a process (an evict process) of allowing the cache entry 301 having made a transition to a clean state to be used by another cache entry is executed. Accordingly, the cache entry 301 having performed the evict process makes a transition from the “clean state 902 or 905” to the “non-existent state 901 or 904”.

When desiring to reuse the cache entry 301 in the “clean state 902 or 905” as an area to cache other data in division units, the evict process is performed to cause a transition to the “non-existent state 901 or 904”.

When the guest OS receives a read request in the “clean state 902 or 905”, contents of the data sections 303 of the cache entry 301 are only updated and a state transition does not take place. In a similar manner, when the guest OS receives a read/write request in the “dirty state 903 or 906”, contents of the data sections 303 of the cache entry 301 are only updated and a state transition does not take place.

When the guest OS receives a write request in the “clean state 902 or 905”, contents of the data sections 303 of the cache entry 301 are only updated and, at the same time, a state transition to the “dirty state 903 or 906” is performed.

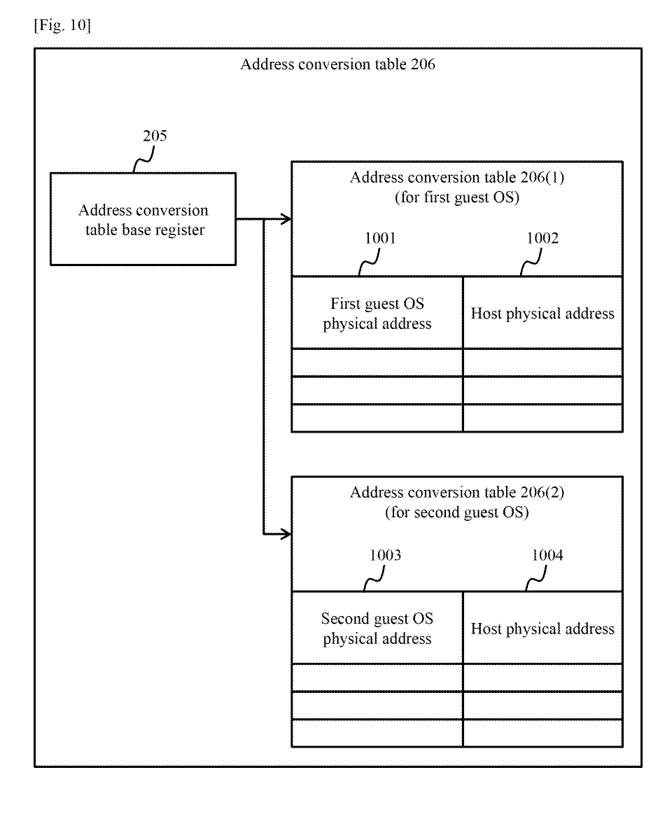

FIG. 10 shows a data structure of the address conversion table 206. The address conversion table 206 includes an address conversion table 206 (1) for the first guest OS 101 and an address conversion table 206 (2) for the second guest OS 102.

When the first guest OS 101 is running on the CPU 203, a value of the address conversion table base register 205 is set to a base address of the first guest OS address conversion table 206 (1). When the second guest OS 102 is running on the CPU 203, the value of the address conversion table base register 205 is set to a base address of the second guest OS address conversion table 206 (2). In this manner, by rewriting a value of the address conversion table base register 205, the main memory 202 can be accessed in a different address space by each guest OS.

The first guest OS address conversion table 206 (1) stores address map information constituted by associations between a first guest OS physical address 1001 and a host physical address 1002. In a similar manner, the second guest OS address conversion table 206 (2) stores address map information constituted by associations between a second guest OS physical address 1003 and a host physical address 1004.

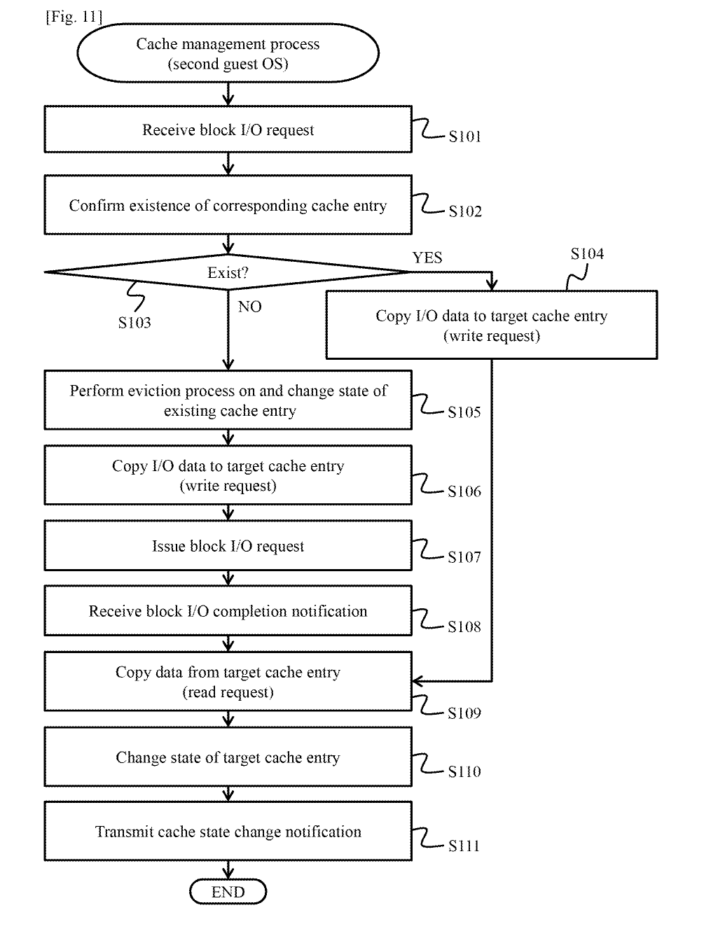

FIG. 11 is a flow chart showing processes by the cache management mechanism 106 (2) of the second guest OS 102.

In step S101, the second guest OS 102 receives a block I/O request. In doing so, the second guest OS 102 also receives a block number of a virtual block device to be a target of the block I/O request. In the case of a write I/O request, the second guest OS 102 also receives data that is a write target (write data).

The cache management mechanism 106 (2) checks whether or not the cache entry 301 storing the data of the block number that is a block I/O target is being cached in the second guest OS cache area 211 (S102). The state of the cache entry 301 storing the data of the block number that is the block I/O target being the “non-existent state” means that data that is the block I/O target is not being cached. The state of the cache entry 301 being a state other than the “non-existent state” means that the data that is the block I/O target is being cached. A state other than the “non-existent state” is either the “dirty state” or the “clean state”.

The cache management mechanism 106 (2) determines an existence of a cache entry that is the block I/O target (S103). When the cache entry exists (S103: YES), the process jumps to step S104. When the cache entry does not exist (S103: NO), the process jumps to step S105.

In step S104, when the I/O request received in step S101 is a write request, the cache management mechanism 106 (2) copies data to be subject to I/O (write data) to the data section 303 of the cache entry 301 that is the block I/O target. Subsequently, the process jumps to step S109.

In step S105, the cache management mechanism 106 (2) performs the evict process on a single cache entry 301 in a clean state among existing cache entries 301 to reserve a cache entry 301 for storing block data that is the block I/O target. The cache management mechanism 106 (2) causes the cache state of the cache entry 301 on which the evict process has been performed to make a transition from the “clean state” to the “non-existent state” in accordance with FIG. 9.

In step S106, in a similar manner to step S104, when the I/O request received in step S101 is a write request, the cache management mechanism 106 (2) writes write data into the data section 303 of the cache entry 301 reserved in step S105.

In step S107, the cache management mechanism 106 (2) issues, via the block I/O communication unit 104, a block I/O request with respect to a virtual block device provided by the first guest OS 101. The block I/O request includes the block number received in step S101, and when the block I/O request is a write I/O request, the block I/O request also includes write data.

In step S108, the cache management mechanism 106 (2) receives a completion notification of the block I/O request issued in step S107 from the first guest OS-side cache management mechanism 106 (1). The block I/O request completion notification is delivered from the cache management mechanism 106 (1) via the block I/O communication unit 104 to the cache management mechanism 106 (2). Moreover, when the block I/O request is a read I/O request, read data is delivered from the cache management mechanism 106 (1) to the cache management mechanism 106 (2) together with the block I/O request completion notification. The read data is copied to the data section 303 of the cache entry 301 reserved in step S105.

Step S109 is only executed when a read I/O request is received in step S101. In this case, before reaching the present step S109, read data has already been stored in either the data section 303 of the cache entry 301 retrieved in step S102 or the data section 303 of the cache entry 301 reserved in step S105. The cache management mechanism 106 (2) copies and notifies the data (read data) to a block I/O request source of step S109.

In step S110, the cache management mechanism 106 (2) updates a state of the target cache entry in accordance with the state transition diagram shown in FIG. 9.

In step S111, the cache management mechanism 106 (2) notifies the cache state management mechanism 107 of changes to the cache state made in step S105 and step S110. A notification of a cache state includes, with respect to the target cache entry 301, a guest OS physical address, a block number, and a new cache state.

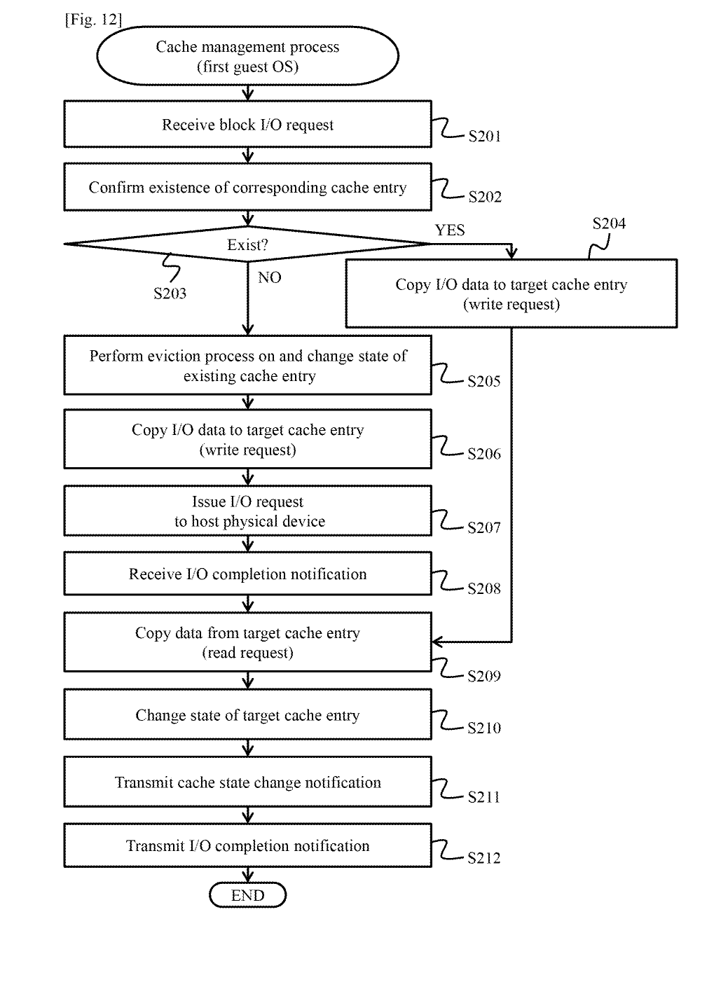

FIG. 12 is a flow chart showing processes by the cache management mechanism 106 (1) of the first guest OS 101.

First, the first guest OS 101 receives a block I/O request from the second guest OS 102 via the block I/O communication unit 104 (S201). Upon receiving the block I/O request from the second guest OS 102, the first guest OS 101 also receives a block number of a virtual block device provided by the first guest OS 101 to the second guest OS 102. When the block I/O request from the second guest OS 102 is a write I/O request, write data is also received.

When the first guest OS 101 receives the block I/O request from the second guest OS 102, the cache management mechanism 106 (1) confirms whether or not the cache entry 301 storing the data of the block number specified by the block I/O request is being cached in the first guest OS cache area 210 (S202).

When the cache state of the cache entry 301 corresponding to the specified block number is the “non-existent state”, it can be determined that the cache entry 301 corresponding to the block I/O request does not exist on the first guest OS cache area 210. When the cache state of the cache entry 301 corresponding to the specified block number is the “clean state” or the “dirty state”, it can be determined that the corresponding cache entry 301 exists on the first guest OS cache area 210.

Based on the confirmation result in step S202, the cache management mechanism 106 (1) determines whether or not the cache entry 301 corresponding to the block I/O request from the second guest OS 102 exists (S203).

When it is determined that the corresponding cache entry 301 exists (S203: YES), the process jumps to step S204. When it is determined that the corresponding cache entry 301 does not exist (S203: NO), the process jumps to step S205.

In step S204, when the block I/O request received in step S201 is a write I/O request, the cache management mechanism 106 (1) copies write data to the data section 303 of the target cache entry 301. Subsequently, the process jumps to step S209.

In step S205, the cache management mechanism 106 (1) performs the evict process on a single cache entry 301 in a clean state among existing cache entries 301 to reserve a cache entry 301 for storing target data of the block I/O request. The cache management mechanism 106 (1) causes the cache state of the cache entry 301 on which the evict process has been performed to make a transition from the “clean state” to the “non-existent state” in accordance with FIG. 9.

In step S206, in a similar manner to step S204, when the block I/O request received in step S201 is a write I/O request, the cache management mechanism 106 (1) copies write data to the data section 303 of the target cache entry 301.

In step S207, the cache management mechanism 106 (1) issues a device I/O request with respect to the host physical device 105. In doing so, the cache management mechanism 106 (1) converts a block number of the virtual block device into a block number of the host physical device 105 and notifies the host physical device 105 of the converted block number together with the device I/O request. In addition, when issuing a write I/O request as the device I/O request, the write data received in step S201 is also transmitted together to the host physical device 105.

In step S208, the cache management mechanism 106 (1) receives a completion notification of the device I/O request issued in step S207. When the device I/O request issued in step S207 is a read I/O request, the cache management mechanism 106 (1) also receives data read from the host physical device 105 together with the completion notification. The cache management mechanism 106 (1) copies the received data (read data) to the data section 303 of the cache entry 301 reserved in step S205.

The cache management mechanism 106 (1) only executes step S209 when a read I/O request is received in step S201. In this case, before reaching step S209, the read data has already been stored in either the data section 303 of the cache entry 301 retrieved in step S202 or the data section 303 of the cache entry 301 reserved in step S205.

The cache management mechanism 106 (1) copies and notifies the read data to the cache management mechanism 106 (2) that is an issuance source of the block I/O request (read I/O request) (S209). Subsequently, the cache management mechanism 106 (1) updates a state of the target cache entry in accordance with the state transition diagram shown in FIG. 9 (S210).

The cache management mechanism 106 (1) notifies the cache state management mechanism 107 of changes made to the cache state in step S205 and step S210 (S211). A notification of a cache state includes, with respect to the target cache entry 301, a guest OS physical address, a block number, and a new cache state.

Finally, the cache management mechanism 106 (1) notifies the cache management mechanism 106 (2) of a block I/O completion notification through the block I/O communication unit 104 (S212).

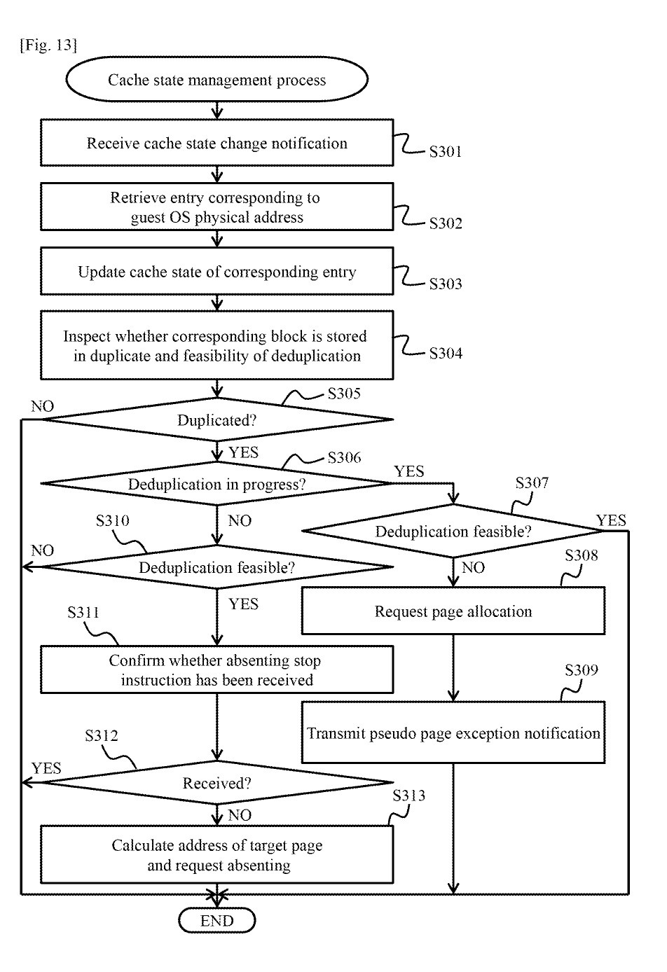

FIG. 13 is a flow chart showing processes by the cache state management mechanism 107. The cache state management mechanism 107 receives a change notification of a cache state from the respective cache management mechanisms 106 (1) and 106 (2) (S301). In doing so, the cache state management mechanism 107 also receives a guest OS physical address, a block number, and a new cache state with respect to the target cache entry 301.

The cache state management mechanism 107 retrieves an entry of a memory allocation table 110 corresponding to the guest OS physical address received in step S301 among the first guest OS memory allocation table 110 (1) and the second guest OS memory allocation table 110 (2) (S302). When the cache state management mechanism 107 receives a cache state change notification from the cache management mechanism 106 (1), the cache state management mechanism 107 retrieves the first guest OS memory allocation table 110 (1). In comparison, when the cache state management mechanism 107 receives a cache state change notification from the cache management mechanism 106 (2), the cache state management mechanism 107 retrieves the second guest OS memory allocation table 110 (2).

The cache state management mechanism 107 updates a field value of the cache state 604 or 608 of the entry retrieved in step S302 with the new cache state received in step S301 (S303).

The cache state management mechanism 107 inspects whether an entry corresponding to the block number received in step S301 exists in duplicate (S304). The cache state management mechanism 107 confirms whether or not an entry corresponding to a block number of which a cache state has been changed exists in both the first guest OS memory allocation table 110 (1) and the second guest OS memory allocation table 110 (2) and, at the same time, both cache states 604 and 608 of the entry are other than the “non-existent state”.

The cache state management mechanism 107 determines whether or not a duplicate entry exists (S305), and when it is determined that a duplicate entry exists (S305: YES), the cache state management mechanism 107 jumps to step S306. When it is determined that a duplicate entry does not exist (S305: NO), the present process is ended.

The cache state management mechanism 107 inspects whether or not a value of the host physical address 605 in the second guest OS memory allocation table 110 (2) obtained in step S304 is set to “absent” (S306). The host physical address 605 set to “absent” means that deduplication is being executed.

When it is determined that deduplication is being executed (S306: YES), the process jumps to step S307. When it is determined that deduplication is not being executed (S306: NO), the process jumps to step S309.

In step S307, the cache state management mechanism 107 inspects whether or not a cache state of an entry of the first guest OS memory allocation table 110 (1) and a cache state of an entry of the second guest OS memory allocation table 110 (2) are both a deduplication-feasible state.

Specifically, when the cache state of an entry in the second guest OS 102 is the “clean state” and the cache state of an entry in the first guest OS 101 is either the “clean state” or the “dirty state”, the cache state management mechanism 107 determines that deduplication is feasible. In other cases, the cache state management mechanism 107 determines that deduplication is infeasible. When the cache state management mechanism 107 determines that deduplication is feasible (S307: YES), the cache state management mechanism 107 ends the present process. When the cache state management mechanism 107 determines that deduplication is infeasible (S307: NO), the cache state management mechanism 107 jumps to step S308.

In step S308, the cache state management mechanism 107 calculates a guest OS address of the second guest OS 102 of a page to which a page is to be allocated. Specifically, the cache state management mechanism 107 reads a field of the guest OS physical address 607 from an entry of the memory allocation table 110 (2) for the second guest OS 102 and transmits a page allocation request to the memory allocation management mechanism 108. The page allocation request also includes the acquired guest OS physical address.

In step S309, the cache state management mechanism 107 issues a pseudo page exception notification to the cache copy mechanism 109. In doing so, the cache state management mechanism 107 sets the guest OS physical address described in step S308 to the page exception occurrence address register 209 and calls the guest OS physical address. Due to step S309, the cache copy mechanism 109 recognizes that a page exception has occurred at the address notified by the cache state management mechanism 107. Accordingly, data copy is executed to the page in which an occurrence of a page exception is recognized as will be described later.

In step S310, the cache state management mechanism 107 inspects whether or not cache states of respective entries of the first guest OS memory allocation table 110 (1) and the second guest OS memory allocation table 110 (2) are a deduplication-feasible state.

Contents of execution of step S310 are the same as step S307. When the cache state management mechanism 107 determines that deduplication is infeasible (S310: NO), the cache state management mechanism 107 ends the present process. When it is determined that deduplication is feasible (S310: YES), the process jumps to step S311.

The cache state management mechanism 107 confirms whether or not an absenting process stop instruction has been received from the cache copy mechanism 109 (S311). In other words, the cache state management mechanism 107 determines whether an instruction to stop the absenting process has been issued from the cache copy mechanism 109 or an instruction to resume the absenting process has been issued from the cache copy mechanism 109 and the stop instruction has been canceled (S311).

When the cache state management mechanism 107 determines that an absenting process stop instruction has been received (S312: YES), the cache state management mechanism 107 ends the present process. When it is determined that an absenting process stop instruction has not been received (S312: NO), the process jumps to step S313.

In step S313, the cache state management mechanism 107 calculates a host physical address of a page to be absented. Specifically, the cache state management mechanism 107 calls a value of the host physical address 605 field in the second guest OS memory allocation table 110 (2). In addition, the cache state management mechanism 107 issues a page absenting request to the memory allocation management mechanism 108. The page absenting request includes a host physical address of the page to be absented.

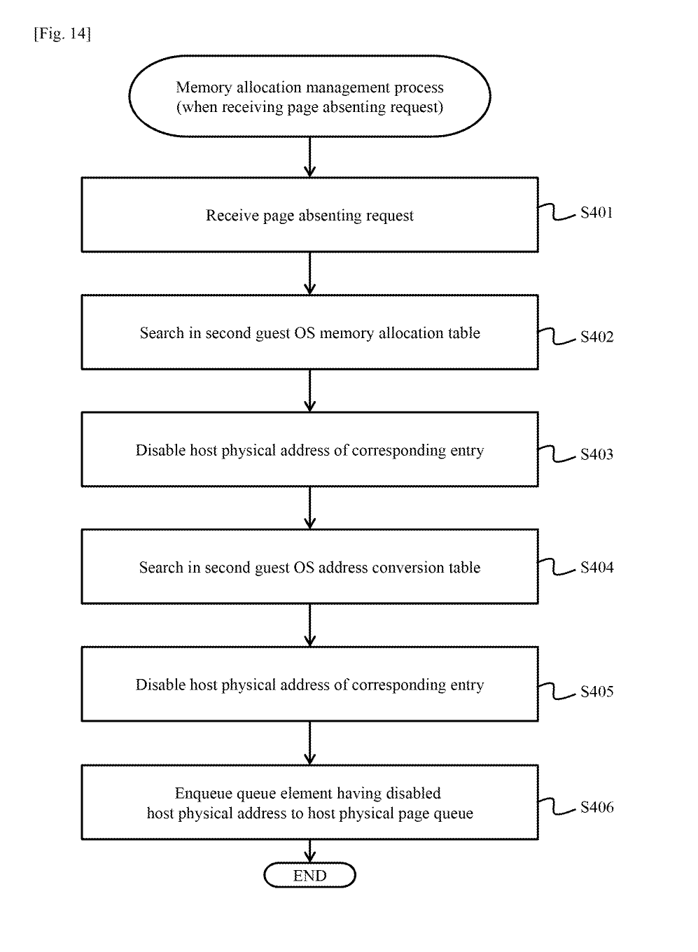

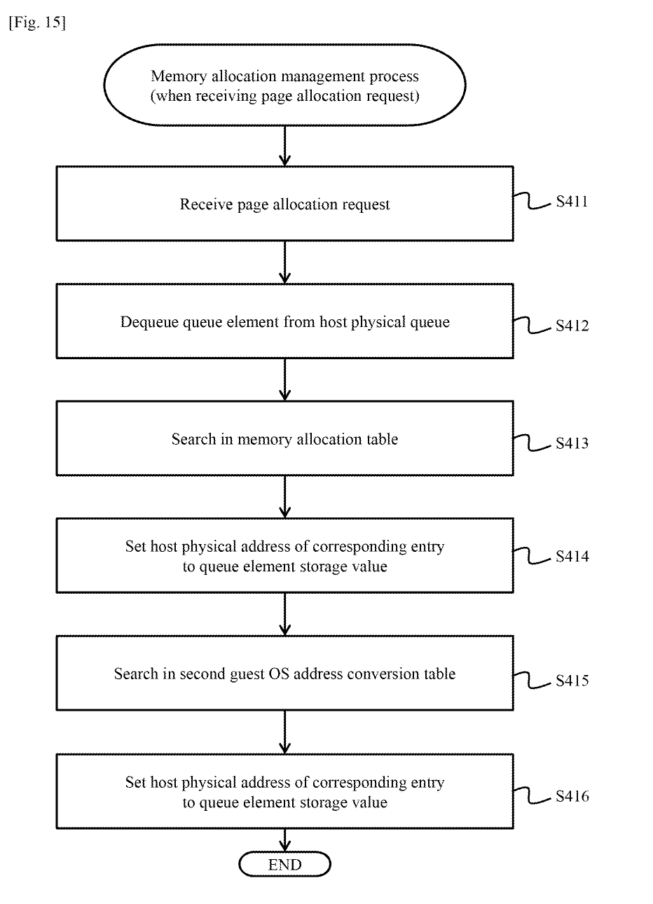

Processes by the memory allocation management mechanism 108 will be described with reference to the flow charts in FIG. 14 and FIG. 15. The memory allocation management mechanism 108 starts operations upon receiving a page absenting request or a page allocation request from the cache state management mechanism 107 or the cache copy mechanism 109.

Processes from step S401 to step S406 shown in FIG. 14 represent a flow chart when the memory allocation management mechanism 108 receives a page absenting request. Processes from step S411 to step S416 shown in FIG. 15 represent a flow chart when the memory allocation management mechanism 108 receives a page allocation request.

Let us now refer to FIG. 14. The memory allocation management mechanism 108 receives a page absenting request from the cache state management mechanism 107 or the cache copy mechanism 109 (S401). The page absenting request includes host physical address information of the page to be subjected to an absenting process.

The memory allocation management mechanism 108 retrieves an entry of the memory allocation table 110 (2) for the second guest OS 102 corresponding to the host physical address received in step S401 (S402).

The memory allocation management mechanism 108 disables a value of the host physical address 605 field of the entry retrieved in step S402 (S403).

The memory allocation management mechanism 108 retrieves an entry of the second guest OS address conversion table 206 (2) corresponding to the host physical address received in step S401 (S404). The memory allocation management mechanism 108 disables a value of the host physical address 1005 field of the entry retrieved in step S404 (S405).

The memory allocation management mechanism 108 creates a queue element of the host physical page queue 113 and enqueues the queue element to the host physical page queue 113 (S406). The queue element created by the memory allocation management mechanism 108 has a value of the host physical address 1005 field of the entry retrieved in step S404.

Let us now refer to FIG. 15. The memory allocation management mechanism 108 receives a page allocation request from the cache state management mechanism 107 or the cache copy mechanism 109 (S411). The page allocation request also includes a guest OS address of the second guest OS 102 to which a host physical page is to be allocated.

The memory allocation management mechanism 108 dequeues a queue element from the host physical page queue 113 (S412). The memory allocation management mechanism 108 retrieves an entry of the memory allocation table 110 (2) for the second guest OS 102 corresponding to the guest OS address received in step S411 (S413).

The memory allocation management mechanism 108 updates a value of the host physical address 605 field of the entry retrieved in step S413 to a value of the host physical address 702 field of the queue element dequeued in step S412 (S414).

The memory allocation management mechanism 108 retrieves an entry of the address conversion table 206 (2) for the second guest OS 102 corresponding to the guest OS address received in step S411 (S415). The memory allocation management mechanism 108 updates a value of the host physical address 1005 field of the entry retrieved in step S415 to a value of the host physical address 702 field of the queue element dequeued in step S412 (S416).

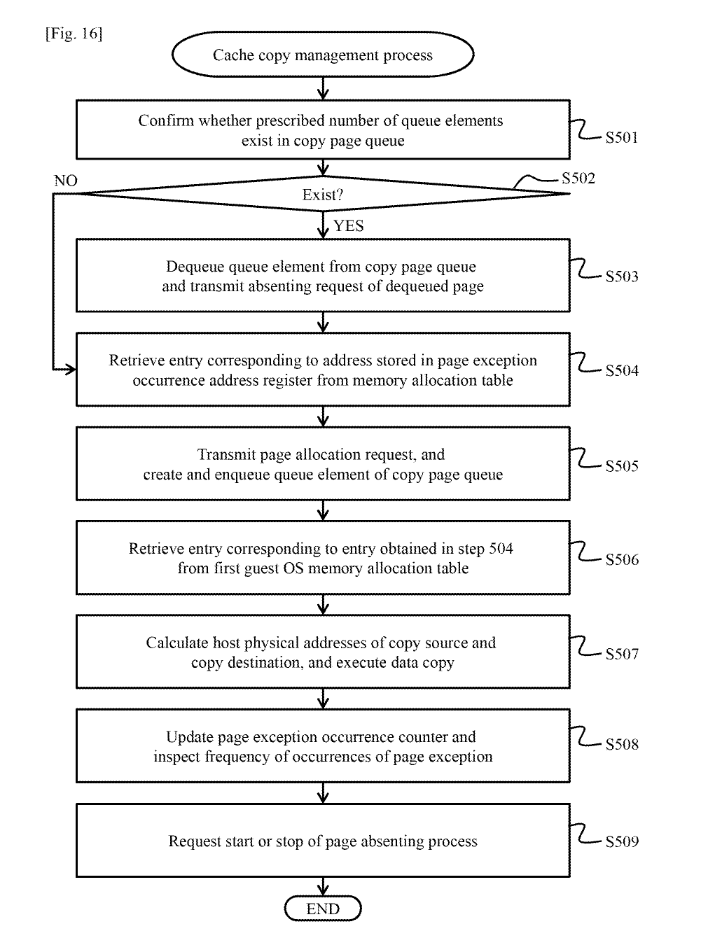

FIG. 16 is a flow chart showing processes by the cache copy mechanism 109. The cache copy mechanism 109 confirms whether or not a prescribed number of queue elements exist in the copy page queue 114 (S501). When the cache copy mechanism 109 determines that the prescribed number of queue elements exist in the copy page queue 114 (S502: YES), the cache copy mechanism 109 jumps to step S503. When it is determined that the prescribed number of queue elements do not exist (S502: NO), the cache copy mechanism 109 jumps to step S504.

In step S503, the cache copy mechanism 109 dequeues one head queue element of the copy page queue 114. In addition, the cache copy mechanism 109 transmits an absenting request with respect to a host physical page corresponding to the dequeued queue element to the memory allocation management mechanism 108 (S503). The absenting request also includes a value stored in the host physical address 802 of the queue element described above.

In S504, the cache copy mechanism 109 retrieves an entry of the second guest OS memory allocation table 110 (2) corresponding to the guest OS address stored in the page exception occurrence address register 209.

The cache copy mechanism 109 transmits a page allocation request to the memory allocation management mechanism 108 (S505). The page allocation request also includes a value of the page exception occurrence address register 209 read in step S504. Accordingly, a value of the host physical address 605 field of the entry retrieved in step S504 by the memory allocation management mechanism 108 is updated. The cache copy mechanism 109 creates a queue element including the updated value of the field in the host physical address 802 field and enqueues the created queue element to the copy page queue 114 (S505).

The cache copy mechanism 109 retrieves an entry of the first guest OS memory allocation table 110 (1) corresponding to the block number 606 of the entry retrieved in step S504 (S506).

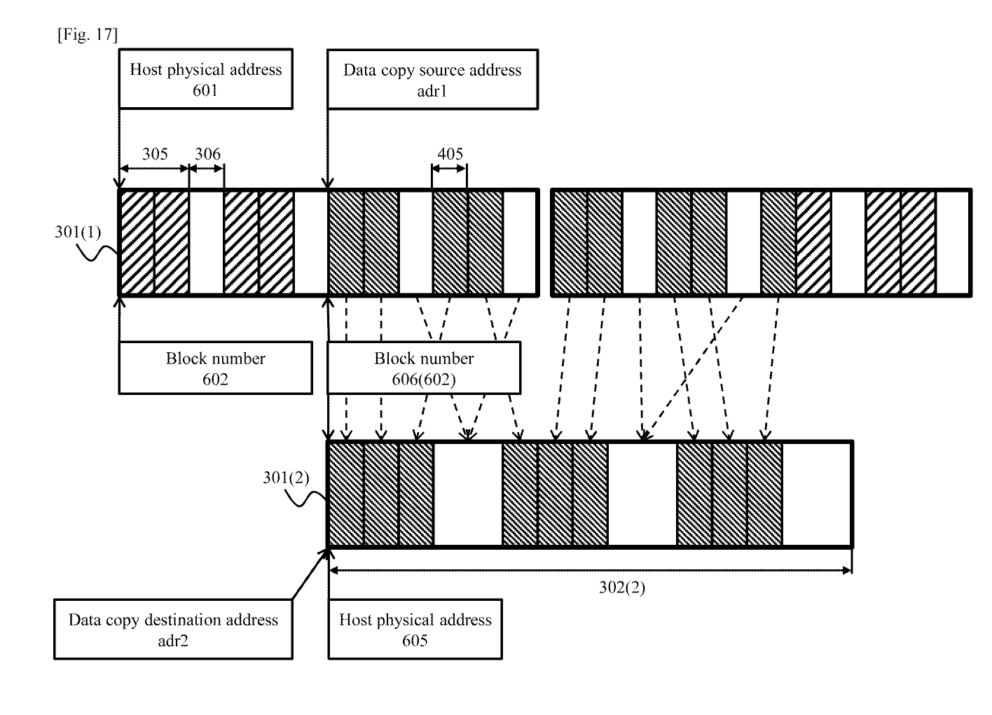

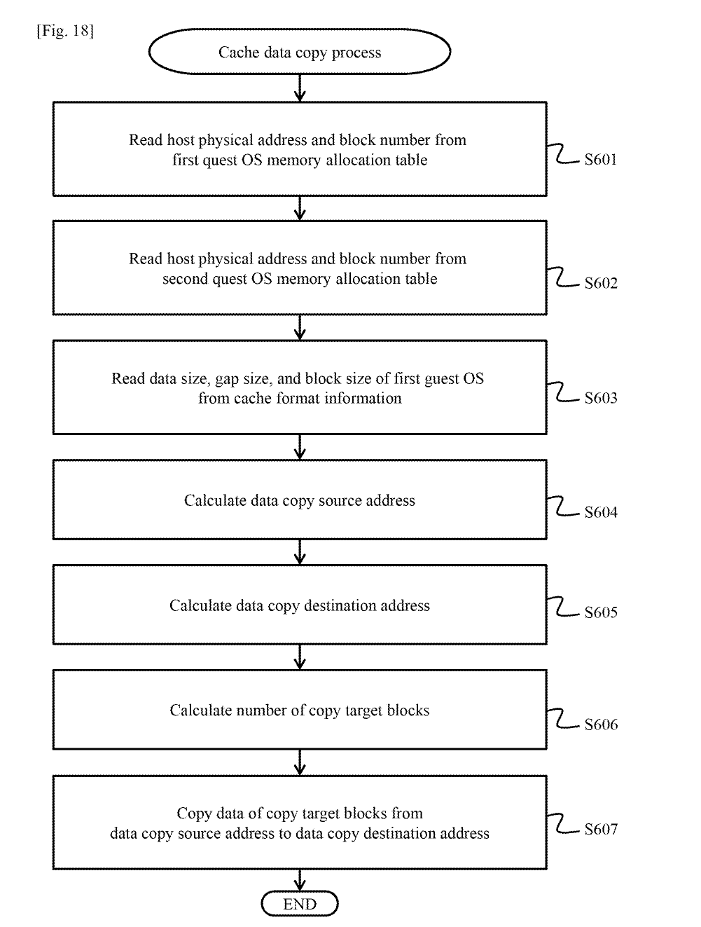

The cache copy mechanism 109 calculates a copy source host physical address and a copy destination host physical address from entries retrieved in step S504 and step S506 and information stored in the cache format information 111, and executes data copy (S507). A detailed example of step S507 will be described later with reference to FIG. 17 and FIG. 18.

In step S508, the cache copy mechanism 109 updates the page exception occurrence counter 112. Specifically, the cache copy mechanism 109 counts up latest entries in the history of counted number of occurrences 502.

In addition, the cache copy mechanism 109 calculates an average value of a prescribed number of latest values among the values stored in the history of counted number of occurrences 502 and stores the average value in the latest average 503 (S508). At the same time, the cache copy mechanism 109 deletes an entry of the oldest history of counted number of occurrences 502.

When the latest average calculated in step S508 exceeds a prescribed reference value, the cache copy mechanism 109 transmits an instruction to stop a page absenting process to the cache state management mechanism 107 (S509). Alternatively, when the latest average calculated in step S508 equals or falls below the prescribed reference value, the cache copy mechanism 109 transmits an instruction to resume the page absenting process to the cache state management mechanism 107 (S509).

FIG. 17 shows a method by which the cache copy mechanism 109 determines a copy source address and a copy destination address.

A head host physical address 601 of the corresponding first guest OS cache entry 301 (1) and a block number 602 are obtained from the entry retrieved in step S506 shown in FIG. 16.

In a similar manner, a head host physical address 605 of the corresponding second guest OS cache entry 301 (2) and a block number 606 are obtained from the entry retrieved in step S504 shown in FIG. 16.

The format information 111 includes information on the data size 305, the gap size 306, and the block size 405 of the first guest OS. Therefore, based on the pieces of information 305, 306, and 405, a host physical address of the data section 303 corresponding to the block number 602 of the first guest OS cache entry 301 (1) can be calculated. The cache copy mechanism 109 determines the calculated host physical address as a data copy source address adr1. In addition, the cache copy mechanism 109 can determine a head host physical address 605 of the second guest OS cache entry 301 (2) as a data copy destination address adr2.

The format information 111 also stores the entry size 302, the data size 305, the gap size 306, and the block size 405 of the second guest OS 102. Therefore, from the pieces of information 302, 305, 306, and 405, the cache copy mechanism 109 can calculate the number of copy blocks included in the second guest OS cache entry 301 (2).

By coping data corresponding to the calculated number of copy blocks from the data copy source address adr1 to the data copy destination address adr2, the data copy in step S507 shown in FIG. 16 is executed.

FIG. 18 is a flow chart representing the determination process of a copy source address and a copy destination address and a data copy execution process by the cache copy mechanism 109.

The cache copy mechanism 109 reads information on the host physical address 601 and the block number 602 from the entry of the memory allocation table 110 (1) for the first guest OS 101 retrieved in step S506 (S601).

The cache copy mechanism 109 reads information on the host physical address 605 and the block number 606 from the entry of the memory allocation table 110 (2) for the second guest OS 102 retrieved in step S504 (S602).

The cache copy mechanism 109 reads information on the data size 305, the gap size 306, and the block size 405 of the first guest OS from the cache format information 111 (S603).

Based on the information obtained in steps S601 to S603, the cache copy mechanism 109 calculates a data copy source address as described with reference to FIG. 17 (S604). In addition, the cache copy mechanism 109 determines the host physical address obtained in step S602 as a data copy destination address (S605).

The cache copy mechanism 109 reads information on the entry size 302, the data size 303, the gap size 304, and the block size 405 of the second guest OS 102 from the cache format information 111 (S606). Based on the pieces of information 302, 303, 304, and 405, the cache copy mechanism 109 calculates the number of copy blocks stored in the cache entry as described with reference to FIG. 17 (S606).

Finally, the cache copy mechanism 109 executes data copy a number of times corresponding to the number of copy blocks calculated in step S606 (S607). In accordance with the data copy process, the data copy source address and the data copy destination address are updated in accordance with the data size and the gap size of the first guest OS and the data size and the gap size of the second guest OS. Accordingly, data copy in block units is executed.

In the present embodiment configured as described above, even when cache formats of the first guest OS 101 and the second guest OS 102 differ from each other, a host physical page to be associated with the second guest OS cache area 211 can be absented. Therefore, even when cache formats of the first guest OS 101 and the second guest OS 102 differ from each other, data stored in duplicate can be eliminated and usage of a host physical memory can be reduced.

This is because, in the present embodiment, as described above, when the second guest OS 102 accesses a cache entry of which an association with a host physical page has been released, the cache copy mechanism 109 detects an absence of the host physical page and restores stored contents of the data section 303 of the cache entry 301 in accordance with the cache format information 111.

In addition, in the present embodiment, a queue length of the copy page queue 114 is limited to or below a prescribed number. Accordingly, in the present embodiment, the use of a prescribed number or more of host physical pages in order to restore the data section 303 is suppressed. Therefore, in the present embodiment, a host physical memory can be used with higher efficiency.

Furthermore, in the present embodiment, by monitoring a frequency of occurrences of a page exception with the page exception occurrence counter 112, when page exceptions frequently occur, a page absenting process can be stopped to prevent I/O performance of a virtual block device used by the second guest OS 102 from declining. For example, when an access locality to the virtual block device by the second guest OS 102 is high and a cache hit rate is high, the frequency of occurrences of a page exception increases. In this case, a restoration process of the data section 303 is to be performed frequently and the I/O performance of the virtual block device declines. In contrast, in the present embodiment, since the page absenting process is stopped in accordance with the frequency of occurrences of a page exception, the host physical memory can be efficiently used while preventing the I/O performance of the virtual block device from declining.

The present invention is not limited to the embodiment described above. Various additions, modifications, and the like of the present invention will occur to those skilled in the art without departing from the scope of the invention.

### REFERENCE SIGNS LIST

101 First guest OS
102 Second guest OS
103 Hypervisor
104 Block I/O communication unit
105 Host physical device
106 Cache management mechanism
107 Cache state management mechanism
108 Memory allocation management mechanism
109 Cache copy mechanism
110 Memory allocation table
111 Cache format information
112 Page exception occurrence counter
113 Host physical page queue
114 Copy page queue

1. A computer system, comprising:
a physical resource including a memory;
a virtualization mechanism configured to provide a first virtual computer and a second virtual computer by allocating the physical resource and to manage a cache configuration of the first virtual computer and a cache configuration of the second virtual computer in association with each other; and
a cache state management mechanism configured to manage a cache state of each of the virtual computers, wherein
the cache state management mechanism manages respective cache states of the first virtual computer and the second virtual computer,
upon detection of a transition of the cache state by the cache state management mechanism, when there is a duplicated area which stores same data in a memory area associated with a cache of the first virtual computer and a memory area associated with a cache of the second virtual computer, the virtualization mechanism executes deduplication processing which releases the memory area of the second virtual computer corresponding to the duplicated area by releasing an association between the memory area and the cache of the second virtual computer, and
when a prescribed exception handling occurs due to the second virtual computer accessing the cache previously associated with the released memory area, the virtualization mechanism associates a prescribed memory area with the cache in which the prescribed exception handling has occurred, converts data stored in the cache of the first virtual computer corresponding to the duplicated area from the cache configuration of the first virtual computer to the cache configuration of the second virtual computer, and copy the converted data to the prescribed memory area.

2. The computer system according to claim 1, wherein
the first virtual computer is a virtual computer configured to provide a virtual block device to the second virtual computer and, when receiving an I/O request with respect to the virtual block device from the second virtual computer, issue an I/O request to a target I/O device,
the second virtual computer is a virtual computer for executing an application program issuing the I/O request with respect to the virtual block device, and
the virtualization mechanism notifies the first virtual computer of an I/O request with respect to the virtual block device from the second virtual computer.

3. The computer system according to claim 1, wherein
the virtualization mechanism performs management so that usage of the prescribed memory area equals or falls below a prescribed amount.

4. The computer system according to claim 1, wherein
the virtualization mechanism migrates to a state where the deduplication processing is not executed when a frequency of occurrences of the prescribed exception handling exceeds a prescribed reference value.

5. The computer system according to claim 4, wherein
the virtualization mechanism migrates to a state where the deduplication processing is executable when the frequency of occurrences of the prescribed exception handling equals or falls below the prescribed reference value.

6. The computer system according to claim 1, wherein
the virtualization mechanism determines that the duplicated state exists when the cache state of the first virtual computer and the cache state of the second virtual computer are both clean or when the cache state of the first virtual computer is dirty and the cache state of the second virtual computer is clean.

7. The computer system according to claim 1, wherein
the first virtual computer, when receiving an I/O request with respect to the virtual block device from the second virtual computer via the virtualization mechanism, issues an I/O request to a target I/O device, reads prescribed data in data stored by the I/O device, and stores the read data in a cache entry of the cache of the first virtual computer,
the second virtual computer stores the prescribed data recognized as being stored in the virtual block device in a cache entry of the cache of the second virtual computer,
the first virtual computer notifies the cache state management mechanism of a state of the cache entry of the cache of the first virtual computer as the cache state,
the second virtual computer notifies the cache state management mechanism of a state of the cache entry of the cache of the second virtual computer as the cache state,
the virtualization mechanism, when the cache state management mechanism detects a transition of the cache state, determines whether or not deduplication of a cache memory which stores same data as the cache entry of the first virtual computer in the cache entry of the second virtual computer is feasible,
the virtualization mechanism stores cache format information as information for managing the cache configuration of the first virtual computer and the cache configuration of the second virtual computer in association with each other,
the virtualization mechanism stores a memory allocation table for managing associations between each of the cache entries managed by the first virtual computer, each of the cache entries managed by the second virtual computer, a block number of each block of the virtual block device, each of the blocks and an address of a physical page of the I/O device,
the virtualization mechanism, when determining that the deduplication is feasible, releases an association between a prescribed cache entry, the deduplication of which is determined as feasible, among the respective cache entries managed by the second virtual computer and the physical page,
the virtualization mechanism, when the second virtual computer accesses the prescribed cache entry and prescribed exception handling occurs, determines a block number of the virtual block device corresponding to the prescribed cache entry and the cache entry of the first virtual computer corresponding to the block number from the memory allocation table, and
the virtualization mechanism associates a prescribed physical page with the prescribed cache entry and copies the data stored in a cache entry which stores same data as data stored in the prescribed cache entry among the respective cache entries managed by the first virtual computer to the prescribed physical page while performing format conversion in accordance with the cache format information.

8. The computer system according to claim 7, wherein
the cache format information includes a block size of the virtual block device, a size of the cache entry of the first virtual computer, a size of a data area storing data and a size of a gap between the data areas in the cache entry of the first virtual computer, a size of the cache entry of the second virtual computer, and a size of a data area storing data and a size of a gap between the data areas in the cache entry of the second virtual computer.

9. A cache management method for computer system provided with a physical resource including a memory, a virtualization mechanism which provides a first virtual computer and a second virtual computer by allocating the physical resource and which manages a cache configuration of the first virtual computer and a cache configuration of the second virtual computer in association with each other, and a cache state management mechanism which manages a cache state of each of the virtual computers,
the cache management method managing a cache used by each of the virtual computers, and comprising:
operating the cache state management mechanism to manage respective cache states of the first virtual computer and the second virtual computer,
operating, upon detection of a transition of the cache state by the cache state management mechanism, and when there is a duplicated area which stores same data in a memory area associated with a cache of the first virtual computer and a memory area associated with a cache of the second virtual computer, the virtualization mechanism to execute deduplication processing which releases the memory area of the second virtual computer corresponding to the duplicated area by releasing an association between the memory area and the cache of the second virtual computer, and
operating, when prescribed exception handling occurs due to the second virtual computer accessing the cache previously associated with the released memory area, the virtualization mechanism to associate a prescribed memory area with the cache in which the prescribed exception handling has occurred, convert data stored in the cache of the first virtual computer corresponding to the duplicated area from the cache configuration of the first virtual computer to the cache configuration of the second virtual computer, and copy the converted data to the prescribed memory area.

10. The cache management method for a computer system according to claim 9, wherein
the first virtual computer is a virtual computer which provides a virtual block device to the second virtual computer and, when receiving an I/O request with respect to the virtual block device from the second virtual computer, issues an I/O request to a target I/O device,
the second virtual computer is a virtual computer for executing an application program which issues the I/O request with respect to the virtual block device, and
the virtualization mechanism notifies the first virtual computer of an I/O request with respect to the virtual block device from the second virtual computer.

11. The cache management method for a computer system according to claim 9, wherein
the virtualization mechanism performs management so that usage of the prescribed memory area equals or falls below a prescribed amount.

12. The cache management method for a computer system according to claim 9, wherein
the virtualization mechanism migrates to a state where the deduplication processing is not executed when a frequency of occurrences of the prescribed exception handling exceeds a prescribed reference value.

13. The cache management method for a computer system according to claim 9, wherein
the virtualization mechanism migrates to a state where the deduplication processing is executable when a frequency of occurrences of the prescribed exception handling equals or falls below the prescribed reference value.
